(19) United States
(12) Patent Application Publication
(10) Pub. No.: US 2026/0071739 A1
(43) Pub. Date: Mar. 12, 2026

(54) HEADLAMP ASSEMBLY

(71) Applicant: MILWAUKEE ELECTRIC TOOL CORPORATION, Brookfield, WI (US)

(72) Inventor: Peter G. Diamond, West Allis, WI (US)

(21) Appl. No.: 19/323,524

(22) Filed: Sep. 9, 2025

Related U.S. Application Data
(60) Provisional application No. 63/692,999, filed on Sep. 10, 2024.

(51) Int. Cl. F21V 21/084; F21Y 115/10

(52) U.S. Cl. CPC F21V 21/084; F21Y 2115/10

(57) ABSTRACT

A headlamp assembly for use with a piece of headgear, the headlamp assembly including: a strap configured to be removably coupled to the piece of headgear, the strap configured to extend over an apex of the piece of headgear when coupled to the piece of headgear; a light source supported by the strap for illuminating an area surrounding the piece of headgear, the light source configured to emit light along a length of the strap between a front end to a rear end of the strap; and a power source supported by the strap for providing power to the light source.

### CROSS-REFERENCE TO RELATED APPLICATIONS

This application claims priority to U.S. Provisional Ser. No. 63/692,999, filed on Sep. 10, 2024, the entire contents of which are incorporated herein by reference.

### FIELD OF THE INVENTION

The present invention relates to portable lights and, more particularly, to headlamps.

### BACKGROUND

Construction workers, bicyclists, runners, etc. may wear headlamps order to see in low-light conditions while keeping their hands free. It may also be desirable to increase the visibility of these individuals to others (e.g., passing motorists, equipment operators, etc.).

### SUMMARY

In one aspect, the invention provides a headlamp including a strap, a light source, and a power source. The strap is configured to be coupled to a piece of head gear and extend over a top of the piece of headgear. The light source is supported by the strap. The power source is coupled to the light source to provide power to the light source.

In some aspects, the techniques described herein relate to a headgear configured to be worn by a user, the headgear including: a body having a front surface and a rear surface; a headlamp assembly configured to be coupled to the body, the headlamp assembly including a strap configured to be coupled to the body and extending between the front surface and the rear surface over an apex of the body, a light source supported by the strap for illuminating an area surrounding the headgear, the light source configured to emit light along a length of the strap between the front surface to the rear surface; and a power source supported by the strap for providing power to the light source.

In some aspects, the techniques described herein relate to a headlamp assembly including: a first strap having a circumference and configured to be worn about a perimeter of a user's head or a perimeter of a piece of headgear; a second strap coupled to the first strap, extending over an apex of a user's head or the piece of headgear, and extending between opposite sides of the first strap thereby bisecting the circumference of the first strap; a light source supported by the second strap for illuminating an area surrounding a user, the light source configured to emit light along a length of the second strap; and a power source supported by the first strap or the second strap for providing power to the light source.

In some aspects, the techniques described herein relate to a headlamp assembly for use with a piece of headgear, the headlamp assembly including: a strap configured to be removably coupled to the piece of headgear, the strap configured to extend over an apex of the piece of headgear when coupled to the piece of headgear; a light source supported by the strap for illuminating an area surrounding the piece of headgear, the light source configured to emit light along a length of the strap between a front end to a rear end of the strap; and a power source supported by the strap for providing power to the light source.

Other features and aspects of the invention will become apparent by consideration of the detailed description and accompanying drawings.

### BRIEF DESCRIPTION OF THE DRAWINGS

FIG. 1 is a top view of a headlamp embodying the invention.

FIG. 2 is a side schematic view of another headlamp embodying the invention.

FIG. 3 is a top schematic view of the headlamp of FIG. 2.

FIG. 4 is a top schematic view of another headlamp embodying the invention.

FIG. 5 is a top schematic view of another headlamp embodying the invention.

FIG. 6 is a top schematic view of another headlamp embodying the invention.

FIG. 7 is a side schematic view of another headlamp embodying the invention.

FIG. 8 is a top schematic view of the headlamp of FIG. 7.

FIG. 9 is a top schematic view of another headlamp embodying the invention.

FIG. 10 is a top schematic view of another headlamp embodying the invention.

FIG. 11 is a schematic view of a controller for use with the headlamp of FIGS. 2-10.

FIG. 12 is a perspective view of another headlamp embodying the invention.

FIG. 13 is a side view of the headlamp of FIG. 12 emitting a first color of light.

FIG. 14 is a top view of the headlamp of FIG. 12 emitting the first color of light.

FIG. 15 is a side view of the headlamp of FIG. 12 emitting a second color of light.

FIG. 16 is a top view of the headlamp of FIG. 12 emitting the second color of light.

FIG. 17 is a schematic view of a controller for use with the headlamp of FIGS. 12-16.

FIG. 18 is a perspective view of another headlamp embodying the invention.

FIG. 19 is a side view of the headlamp of FIG. 18 emitting a first color of light.

FIG. 20 is a top view of the headlamp of FIG. 18 emitting the first color of light.

FIG. 21 is a side view of the headlamp of FIG. 18 emitting a second color of light.

FIG. 22 is a top view of the headlamp of FIG. 18 emitting the second color of light.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

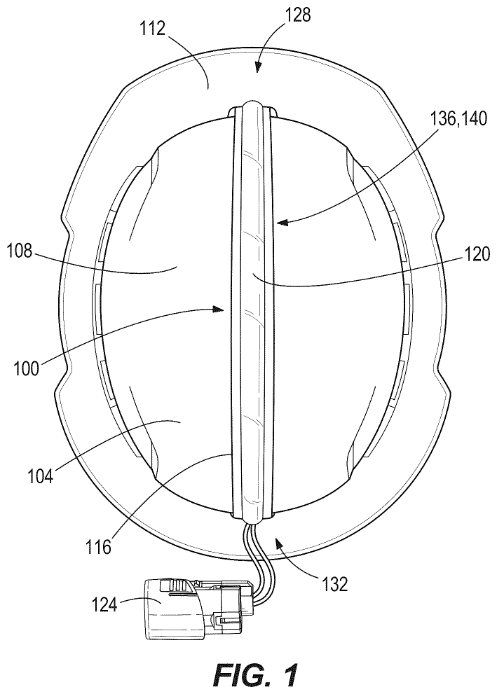

FIG. 1 illustrates a headlamp 100. In the illustrated embodiment, the headlamp 100 is usable with a piece of headgear, such as a hard hat 104. The hard hat 104 includes a main body 108 (or shell) and a brim 112 extending radially outward from the main body 108. The hard hat 104 may also include a harness and/or headband within the main body 108 to fit a user's head. In other embodiments, the headlamp 100 may be worn over a different piece of headgear, such as a baseball cap or a snow cap. In still other embodiments, the headlamp 100 may be worn directly on a user's head.

The illustrated headlamp 100 includes a strap 116, a light source 120, and a power source 124. The strap 116 is configured to extend from a front 128 to a rear 132 of the hard hat 104 over a top 136 of the main body 108. More particularly, the strap 116 is configured to extend over a crest or apex 140 of the main body 108. The strap 116 may be a linear strap that extends directly from the front 128 to the rear 132 of the hard hat 104.

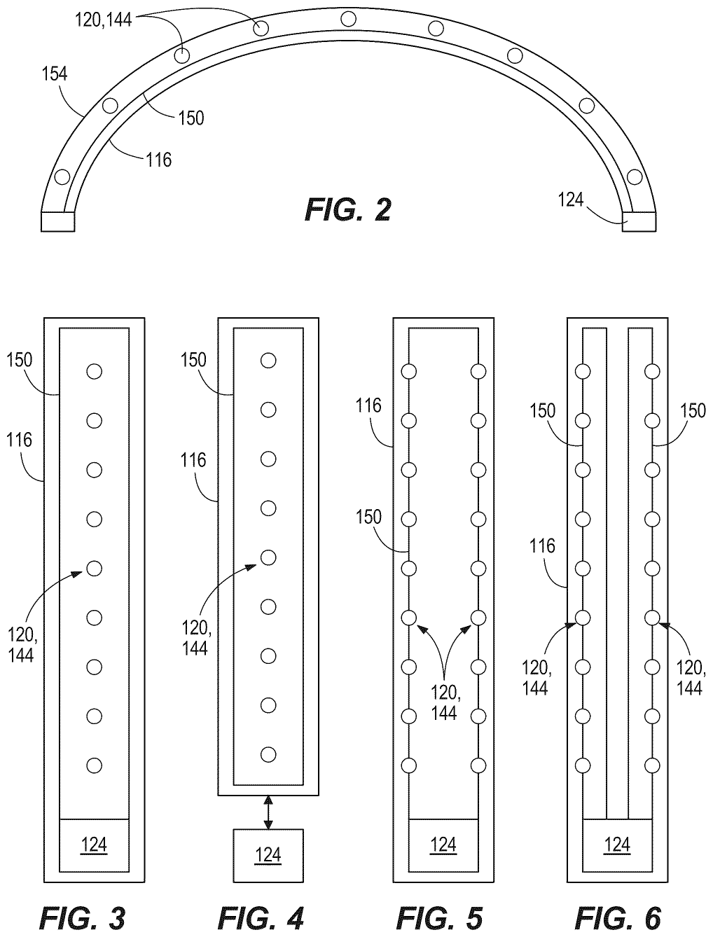

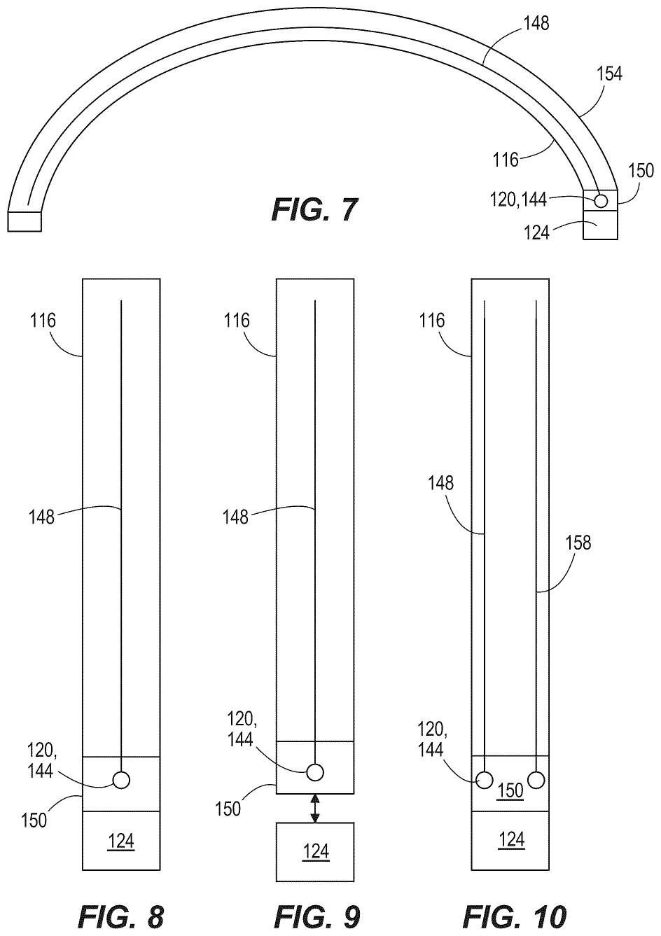

The light source 120 is supported by the strap 116. The light source 120 also extends from the front 128 to the rear 132 of the hard hat 104 over the top 136 of the main body 108. The light source 120 may include one or more light emitting diodes 144 (LEDs 144, shown in FIGS. 2-10). For example, the light source 120 may include a plurality of LEDs 144 spaced apart along a length of the strap 116 between a front end and a rear end. Alternatively, the light source 120 may include a single or multiple LEDs 144 positioned at one end of the strap 116. In such a configuration, the strap 116 may include a light pipe 148 (shown in FIGS. 7-10) to receive and direct light emitted from the LEDs 144 along the length of the strap 116. In either configuration, light emitted from the light source 120 may be visible in any direction around the hard hat 104. In other words, light emitted from the light source 120 provides 360 degrees visibility around the hard hat 104.

The power source 124 is coupled to the light source 120 to provide power to the light source 120. The power source 124 may be a battery. For example, the power source 124 may be a rechargeable and removable power tool battery pack. The power tool battery pack may be a 12-volt Li-ion battery pack. In other embodiments, the power tool battery pack may have other voltages and/or chemistries. The illustrated power source 124 is located adjacent the rear 132 of the hard hat 104. In other embodiments, the power source 124 may be located adjacent the front 128 or a side of the hard hat 104. In some embodiments, the power source 124 may be supported by the strap 116. In other embodiments, the power source 124 may be separately supported by the hard hat 104.

As shown in FIGS. 2-10, in some embodiments, the strap 116 may include a flexible printed circuit board 150 that is configured to support the light source 120 and in electrical communication with the power source 124. In some embodiments, a flexible and transparent lens 154 may cover all or a portion of the strap 116 and the light source 120 thereof, such that the light source 120 is configured to illuminate or emit light to a surrounding area yet still be protected from dirt, debris, and tampering.

In the embodiments of FIGS. 2-10, for example, the flexible printed circuit board 150 extends along the length of the strap 116 between the front end and the rear end. The flexible printed circuit board 150 may be coupled to a top surface of the strap 116. The top surface is opposite a bottom surface, which is configured to contact the top surface of the hard hat 104. In some embodiments, such as that of FIGS. 2-3, 5-8, and 9, the power source 124 may be positioned at and supported by the front end or the rear end of the strap 116, adjacent to a front end or a rear end of the flexible printed circuit board 150. In other embodiments, the power source 124 may be positioned at and supported by the front end or the rear end of the strap 116 and also supported by the flexible printed circuit board 150.

In the embodiments of FIGS. 2-10, the light source 120 is coupled to and supported by the flexible printed circuit board 150. In the embodiments of FIGS. 2-3 and 4, the light source 120 may include a plurality of LEDs 144 extending along a length of the flexible printed circuit board 150 and positioned opposite sides of the strap 116. The plurality of LEDs 144 of FIGS. 2-4 may be configured to illuminate in a direction away from the top surface of the strap 116. Alternatively, the plurality of LEDs 144 of FIGS. 2-4 may be configured to illuminate, via one or more reflectors, in a direction toward opposite sides (e.g., sides that are between the top surface and the bottom surface) of the strap 116.

In still another embodiment shown in FIG. 5, a first plurality of LEDs 144 may be positioned on a first side of the flexible printed circuit board 150 and the strap 116 and a second plurality of LEDs 144 may be positioned on a second side of the flexible printed circuit board 150 and strap 116. The first and second plurality of LEDs 144 may be configured to illuminate in a direction away from the top surface of the strap 116. Alternatively, the first plurality of LEDs 144 may be configured to illuminate in a direction from a first side of the strap 116 and the second plurality of LEDs 144 may be configured to illuminate in a direction from a second side of the strap 116, opposite the first side.

In still other embodiments (not shown), a third plurality of LEDs 144 may be coupled between the first and second plurality of LEDs 144. The first plurality of LEDs 144 may be configured to illuminate in a direction from the first side of the strap 116, the second plurality of LEDs 144 may be configured to illuminate in a direction from the second side of the strap 116, and the third plurality of LEDs 144 may be configured to illuminated in a direction away from the top surface of the strap 116.

In still another embodiment shown in FIG. 6, a first printed circuit board 150 may extend along the length of the strap 116 between the front end and the rear end and a second printed circuit board 150 may extend along the length of the strap 116 between the front end and the rear end. The first and second flexible printed circuit boards 150 may be spaced apart from one another and in communication with the power source 124. Each of the first and second flexible printed circuit boards 150 may support a plurality of LEDs 144 extending along a length thereof. Each of the plurality of LEDs 144 may be configured to illuminate in a direction away from the top surface of the strap 116. Alternatively, one of the plurality of LEDs 144 may be configured to illuminate from a first side of the strap 116 and the other of the plurality of LEDs 144 may be configured to illuminate from a second side of the strap 116, opposite the first side.

In the embodiments of FIGS. 7-10, for example, both the flexible printed circuit board 150 and the power source 124 may be positioned at and supported by the front end or the rear end of the strap 116. Accordingly, the power source 124 may be adjacent to or supported by the flexible printed circuit board 150, as shown in FIGS. 7-9. Alternatively, the power source 124 may be couplable to the flexible printed circuit board 150. As shown in FIGS. 7-9, the light source 120 may include one or more LEDs 144 supported by the flexible printed circuit board 150 at one of the front or rear ends of the strap 116 and a light pipe 148 extending from the one or more LEDs 144 positioned at the front end or rear end of the strap 116 to the other of the front end or rear end of the strap 116. In these embodiments, as shown, the power source 124 may be supported by the same end of the strap 116 as the one or more LEDs 144. Thus, the light pipe 148 may direct light from the LEDs 144 at one end of the strap 116, having the power source 124, to the opposite end of the strap 116. The light pipe 148 may be configured to illuminate in a direction away from the top surface of the strap 116. Alternatively, the light pipe 148 may be configured to illuminate, via one or more reflectors, in a direction toward opposite sides of the strap 116.

In yet another embodiment shown in FIG. 10, a first light source 120 (e.g., one or more first LEDs 144) may be supported on the flexible printed circuit board 150 and a second light source 120 (e.g., one or more second LEDs 144) may be supported on the flexible printed circuit board 150. A first light pipe 148 may extend the first LEDs 144 to the opposite end of the strap 116. A second light pipe 148 may extend from the second LEDs 144 to the opposite end of the strap 116. The light pipes 148 may each be configured to illuminate in a direction away from the top surface of the strap 116. Alternatively, the first light pipe 148 may be configured to illuminate in a direction away from the first side of the strap 116 and the second light pipe 148 may be configured to illuminate in a direction away from the second side of the strap 116.

In any of the embodiments of FIGS. 1-10 the light source 120 may be configured to illuminate a single color or multiple colors and in any suitable brightness level or pattern (e.g., uninterrupted light, blinking light, etc.).

In some embodiments, the strap 116 may be irremovably coupled to the hard hat 104. In other embodiments, the strap 116 may be removably coupled to the hard hat 104. For example, in some embodiments, a bottom surface of the strap 116 may be adhesively coupled to the top surface of the hard hat 104. In other embodiments, the hard hat 104 might have a front connector and a rear connector, which are configured to receive a mating interface of a connector on the front and rear ends of the strap 116 for removably coupling the strap 116 to the hard hat 104. The connectors may include, for example, snaps, clips, buckles, fasteners, magnets, and the like.

As noted above, the power source 124 may be supported by strap 116 (FIGS. 2-3, 5-8, and 10). For example, in some embodiments, the strap 116 may support the light source 120 and the power source 124. In other embodiments, the power source 124 may be separately supported by the hard hat 104. For example, the power source 124 may be coupled to the hard hat 104, and the strap 116 may include an electrical and mechanical connector that is configured to be removably coupled to a port of or in communication with the power source 124. In such case, the strap 116 may be coupled to the power source 124 via the connector and to the top surface of the hard hat via any suitable method (e.g., adhesives, fasteners, clips, another headlamp assembly, etc.).

In any embodiments disclosed herein the headlamp may include a controller 170 that is configured to electrically communicate with the power source 124 and the light source 120. In some embodiments, the controller 170 may be positioned on the flexible circuit board 150, while in other embodiments, the controller 170 may be positioned on its own circuit board (not shown) that is in electrical communication with the flexible circuit board 150. The controller 170 may also be in communication with one or more actuators 174 that can be used to control the light source 120 of the strap. For example, the controller 170 may be configured to turn the light source 120 off and on using one of the actuators 174. Moreover, one or more actuators 174, via communication with the controller 170, may be configured to adjust a brightness level, change an illumination pattern, or a change a color of light source 120.

FIGS. 12-16 illustrate another headlamp 200. Similar to the headlamp 100 of FIG. 1, the illustrated headlamp 200 includes a strap 204, a light source 208, and a power source. In this embodiment, the strap 204 may be referred to as a first strap. The strap 204 may include any combination of features discussed relative to FIGS. 1-11.

In the illustrated embodiment, the headlamp 200 also includes a second strap 212 having a circumference extending around a perimeter or circumference of the hard hat 104. The second strap 212 may also be called a headband. The first strap 204 is coupled to opposite sides of the second strap 212 and bisects the second strap 212. In addition, the headlamp 200 includes a front light source 216 and a rear light source 220. The front light source 216 is located adjacent the front 128 of the hard hat 104 at an intersection of the first strap 204 and the second strap 212. The rear light source 220 is located adjacent the rear 132 of the hard hat 104 at an intersection of the first strap 204 and the second strap 212. The front and rear light sources 216, 220 may also be powered by the power source.

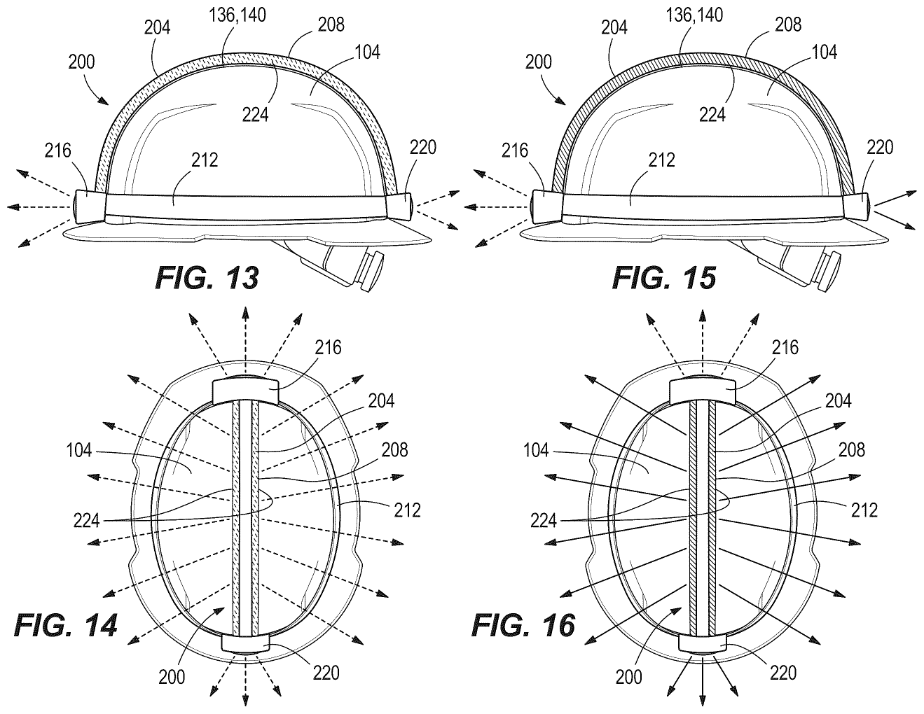

In the illustrated embodiment, the light source 208 is configured to emit light from side edges 224 of the first strap 204. In such case, the light sources 208 may be configured similarly to the light sources 120 of FIGS. 2-10, discussed above. As shown in FIGS. 13 and 14, the light source 208 may emit light having a first color (e.g., white). As shown in FIGS. 15 and 16, the light source 208 may also and alternately emit light having a second color (e.g., red). In other embodiments, the light source 208 may emit light in other colors or patterns of colors in one or more brightness levels.

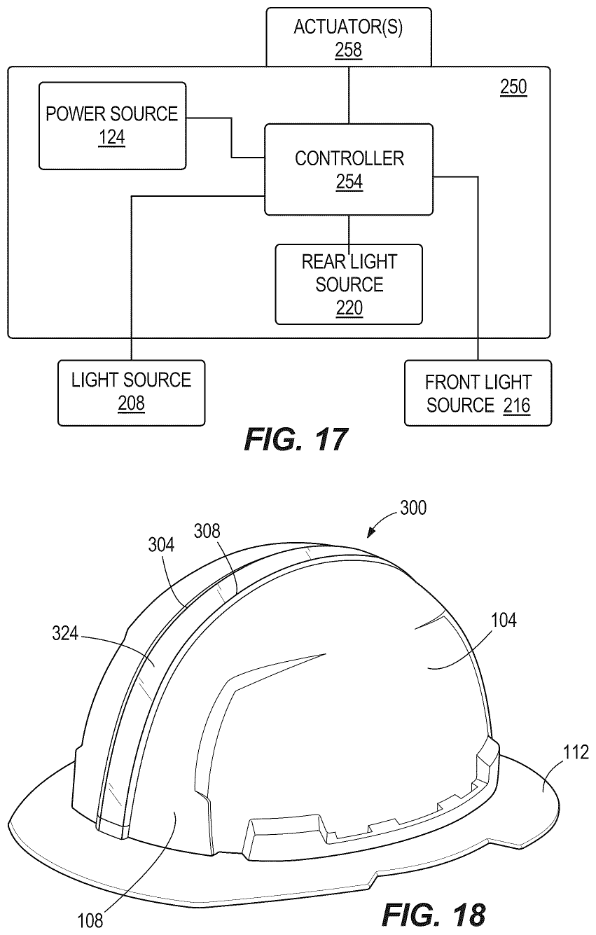

In some embodiments, a single power source 124 may provide power to each of the light sources 208, 216, 220. For example, as shown in FIG. 17, the power source 124 may be provided in a housing 250 that also supports the rear light source 220 and a controller 254. Accordingly, for example, a first wire may be electrically and physically coupled between the front light source 216 and the controller 254 to provide power and control from the same to the front light source 216. Similarly, a second wire may be electrically and physically coupled between the light source 208 and the controller 254 to provide power and control from the same to the light source 208.

Additionally, the housing 250 may include one or more actuators 258 in electrical communication with the controller 254 and configured to selectively illuminate each of the light sources 208, 216, 220 individually or in any combination. Moreover, the actuators 258 may be configured to adjust a brightness level, change an illumination pattern, or a change a color of each of the light sources 208, 216, 220, collectively or individually.

In other embodiments, the power source 124 may alternatively be positioned outside the housing 250 and could be removably coupled to the housing 250. In other embodiments, the power source 124 may be positioned in a housing 250 that supports one of the other light sources 208, 216 and the controller 254, such that the power source 124 and controller 254 may provide power and control remotely to the other light sources 208, 216, 220.

In a specific example, the first strap 204 may be removably coupled to the second strap 212 to removably couple the light source 208 relative to the other light sources 216, 220. In such case, the first strap 204 may include an electrical connector for coupling to a port of the housing 250, such that the light source 208 may be selectively in electrical communication with the controller 250 and power source 124. Moreover, the first strap 204 may include mechanical connectors for physically coupling the front and rear ends of the strap 204 to the second strap 212 or the housing 250 supporting of each of the front and rear light sources 216, 220.

In another embodiment, the light sources 216, 220 of the second strap 212 may be powered by one power source 124 (in a similar manner to the that discussed above with respect to FIG. 18) and the light source 208 of the first strap 204 may be powered by another power source (as discussed above with respect to FIGS. 2-11). In such case, the first strap 204 may be removably mechanically coupled to the second strap 212, removably mechanically coupled to the hard hat 104, or both.

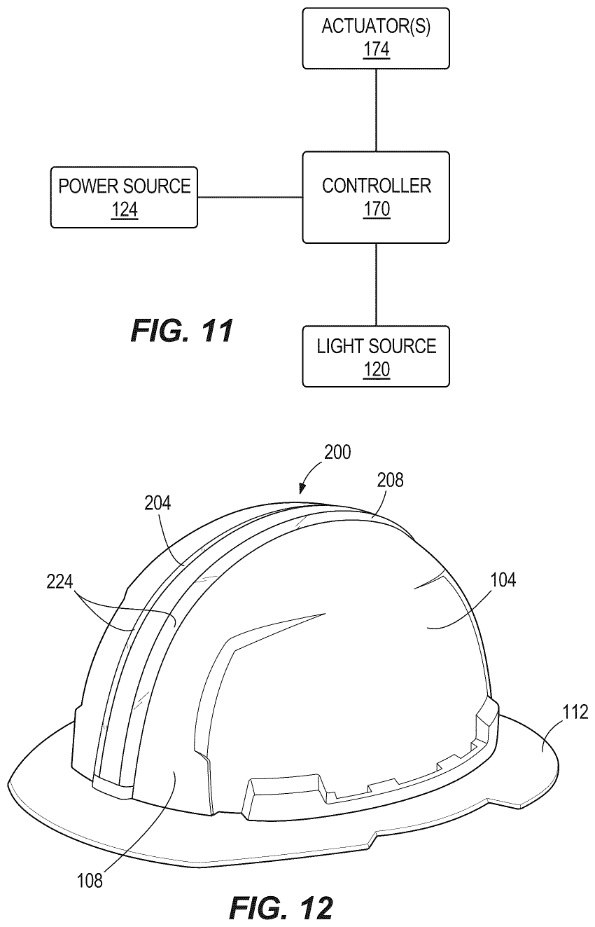

In other embodiments, each of the light sources 208, 216, 220 may be powered by its own power source. Accordingly, each of the light sources 208, 216, 220 and the corresponding power source may be in electrical communication with a controller, like that of controller 170 of FIG. 11, for example.

FIGS. 18-22 illustrate another headlamp 300. Similar to the headlamp 100 of FIG. 1, the illustrated headlamp 300 includes a strap 304, a light source 308, and a power source. In this embodiment, the strap 304 may be referred to as a first strap. In the illustrated embodiment, the headlamp 300 also includes a second strap 312 has a circumference extending around a perimeter or circumference of the hard hat 104. The second strap 312 may also be called a headband. The first strap 304 is coupled to opposite sides of the second strap 312 and bisects the second strap 312. In addition, the headlamp 300 includes a front light source 316 and a rear light source 320. The front light source 316 is located adjacent the front 128 of the hard hat 104 at an intersection of the first strap 304 and the second strap 312. The rear light source 320 is located adjacent the rear 132 of the hard hat 104 at an intersection of the first strap 304 and the second strap 312. The front and rear light sources 316, 320 may also be powered by the power source.

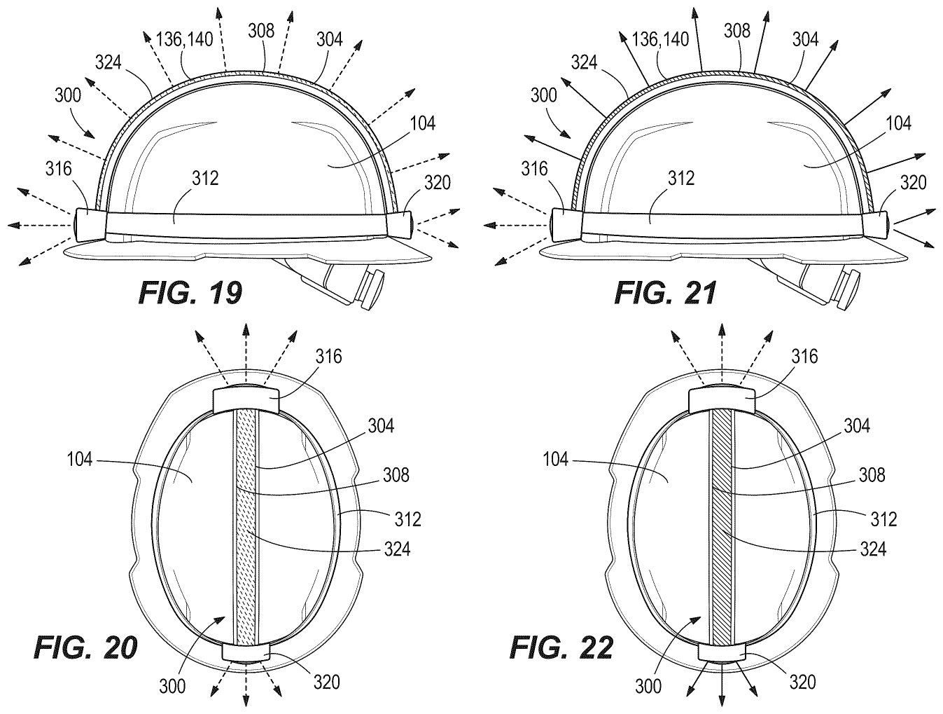

In the illustrated embodiment, the light source 308 is configured to emit light from an upper surface 324 of the first strap 304. The upper surface 324 of the strap 304 is the surface facing away from the hard hat 104. In such case, the light sources 308 may be configured in as similar to way to the light sources of FIGS. 2-10, discussed above. As shown in FIGS. 19 and 20, the light source 308 may emit light having a first color (e.g., white). As shown in FIGS. 21 and 22, the light source 308 may also and alternately emit light having a second color (e.g., red). In other embodiments, the light source 308 may emit light in other colors or patterns of colors.

The light sources 308, 316, 320 may be powered and controlled in a similar way as the light sources 120, 208, 212, 216 discussed above. Therefore, although not explicitly discussed relative to the embodiments of FIGS. 18-22, it should be understood that connection of the power source(s) 124 and the controller 170, 254 discussed with respect to FIGS. 11 and 18 apply equally to the embodiments of FIGS. 18-22.

Various features of the invention are set forth in the following claims.

What is claimed is:

1. A headgear configured to be worn by a user, the headgear comprising:
a body having a front surface and a rear surface;
a headlamp assembly configured to be coupled to the body, the headlamp assembly including
a strap configured to be coupled to the body and extending between the front surface and the rear surface over an apex of the body,
a light source supported by the strap for illuminating an area surrounding the headgear, the light source configured to emit light along a length of the strap between the front surface to the rear surface; and
a power source supported by the strap for providing power to the light source.

2. The headgear of claim 1, wherein the headlamp assembly is removable from the body.

3. The headgear of claim 1, wherein the light source is a first light source, wherein the headlamp assembly further includes a second light source supported by the strap for illuminating the area surrounding the headgear, and wherein
the first light source is positioned on a first side of the strap and is configured to emit light in a first direction away from the body; and
the second light source is positioned on a second side of the strap opposite the first side and configured to emit light in a second direction away from the body.

4. The headgear of claim 3, wherein each of the first light source and the second light source includes a plurality of light-emitting diodes extending along the length of the strap.

5. The headgear of claim 3, wherein each of the first light source and the second light source includes
a light-emitting diode positioned adjacent an end of the strap, and
a light pipe extending from the end of the strap toward an opposite end of the strap to guide light from the light-emitting diode along the length of the strap.

6. The headgear of claim 1, wherein the light source is positioned between a first side and a second side of the strap and is configured to emit light away from the body.

7. The headgear of claim 6, wherein the light source includes a plurality of light-emitting diodes spaced apart along the length of the strap.

8. The headgear of claim 6, wherein the light source includes
a light-emitting diode positioned adjacent an end of the strap, and
a light pipe extending from the end of the strap toward an opposite end of the strap to guide light from the light-emitting diode along the length of the strap.

9. The headgear of claim 1, wherein the light source is configured to alternately emit light having a first color and light having a second color that is different from the first color.

10. The headgear of claim 1, wherein the strap is a first strap and the light source is a first light source, wherein the headlamp assembly further includes a second strap configured to surround a perimeter of the body, the second strap configured to support one or more second light sources, the one or more second light sources positioned at or adjacent the front surface, at or adjacent the rear surface, or at or adjacent both the front surface and the rear surface.

11. A headlamp assembly comprising:
a first strap having a circumference and configured to be worn about a perimeter of a user's head or a perimeter of a piece of headgear;
a second strap coupled to the first strap, extending over an apex of a user's head or the piece of headgear, and extending between opposite sides of the first strap thereby bisecting the circumference of the first strap;
a light source supported by the second strap for illuminating an area surrounding a user, the light source configured to emit light along a length of the second strap; and
a power source supported by the first strap or the second strap for providing power to the light source.

12. The headlamp assembly of claim 11, wherein the light source is a first light source, wherein the headlamp assembly further comprises a second light source supported by the second strap for illuminating the area surrounding the user, and wherein
the first light source is positioned on and extends along a first side of the second strap and is configured to emit light in a first direction away from the second strap; and
the second light source is positioned on and extends along a second side of the second strap that is opposite the first side and configured to emit light in a second direction away from the second strap.

13. The headlamp assembly of claim 11, wherein the light source is positioned between a first side and a second side of the second strap, extends along the length of the second strap, and is configured to emit light in a direction away from a top surface of the second strap.

14. The headlamp assembly of claim 11, wherein the second strap includes a flexible printed circuit board extending along the length of the second strap between a front end and a rear end of the second strap and in electrical communication with the power source, and wherein the light source includes a plurality of light-emitting diodes spaced apart along a length of the flexible printed circuit board.

15. The headlamp assembly of claim 11, wherein the light source includes a light-emitting diode positioned adjacent an end of the second strap and a light pipe extending from the end of the strap toward another end of the strap to guide light from the light-emitting diode along the length of the second strap.

16. The headlamp assembly of claim 11, wherein the light source is a first light source, and wherein the headlamp assembly further comprises one or more second light sources positioned at or adjacent either or both intersections of the second strap with the first strap.

17. A headlamp assembly for use with a piece of headgear, the headlamp assembly comprising:
a strap configured to be removably coupled to the piece of headgear, the strap configured to extend over an apex of the piece of headgear when coupled to the piece of headgear;
a light source supported by the strap for illuminating an area surrounding the piece of headgear, the light source configured to emit light along a length of the strap between a front end to a rear end of the strap; and
a power source supported by the strap for providing power to the light source.

18. The headlamp assembly of claim 17, wherein the strap includes a flexible printed circuit board supported by the strap and configured to support the light source, the flexible printed circuit board being in electrical communication with the power source.

19. The headlamp assembly of claim 18, wherein the flexible printed circuit board extends along the length of the strap between the front end and the rear end of the strap, and wherein the light source includes a plurality of light-emitting diodes spaced apart along a length of the flexible printed circuit board.

20. The headlamp assembly of claim 18, wherein the light source includes a light-emitting diode positioned at one of the front end or the rear end of the strap and a light pipe extending from the one of the front end or the rear end of the strap toward the other of the front end or the rear end of the strap to guide light from the light-emitting diode along the length of the strap.
